(19) United States
(12) Patent Application Publication
(10) Pub. No.: US 2015/0153147 A1
(43) Pub. Date: Jun. 4, 2015

(54) DETERMINING A POSITION BY MEASURING ANGLES

(71) Applicant: SIEMENS AKTIENGESELLSCHAFT, Munich (DE)

(72) Inventor: Uwe Krause, Pattensen (DE)

(73) Assignee: SIEMENS AKTIENGESELLSCHAFT, Munich (DE)

(21) Appl. No.: 14/385,237

(22) PCT Filed: Mar. 12, 2013
(86) PCT No.: PCT/EP2013/055023

§ 371 Date: Sep. 15, 2014

(30) Foreign Application Priority Data
Mar. 15, 2012 (DE) 10 2012 204 076.5

(51) Int. Cl. G01B 5/14; E05F 15/70; E06B 3/46; G01B 5/24

(52) U.S. Cl. CPC G01B 5/14; G01B 5/24; E05F 15/70; E06B 3/4636

(57) ABSTRACT

A device and a method determine the position of an object which can be moved in a linear manner. The device includes a contact unit which is coupled to the object such that the contact unit provides an angle signal (α) that is dependent on the position of the object. An angle detecting unit detects the angle signal (α) provided by the contact unit, and an evaluating unit evaluates the angle signal (α) detected by the angle detecting unit. The position of the object is ascertained using an evaluation function (a(X)) during the evaluation process, the evaluation function describing a dependence of the angle signal (α) on the position of the object.

### CROSS REFERENCE TO RELATED APPLICATIONS

This application is based on and hereby claims priority to International Application No. PCT/EP2013/055023 filed on Mar. 12, 2013 and German Application No. 10 2012 204 076.5 filed on Mar. 15, 2012, the contents of which are hereby incorporated by reference.

### BACKGROUND

The invention relates to an apparatus and a method for determining a position of an object which can be moved in a linear manner.

Various such apparatuses and methods are already known for determining a position of a sliding door or an elevator door.

For example, DE 10 2009 042 800 A1 discloses a system comprising a drive unit and a sensor, with which the position of an element moved by the drive unit can be determined. The sensor is a distance meter for measuring a distance between the sensor and the movable element, from which a position of the movable element is determined.

DE 10 2006 040 232 A1 discloses a door drive for an automatic door with a brushless electric motor and a control apparatus for controlling and/or regulating the electric motor. The control apparatus comprises an angle transmitter working on a magnetic principle for generating an angle signal proportionate to the angle of rotation of the motor.

DE 10 2007 060 343 A1 discloses a monitoring apparatus for monitoring the movement of a wing of a powered gate with a position detection device for detecting a position of the wing. The position detection device has a distance measuring device for measuring a distance of a wing region from a stationary region using wave transmission.

Known from a German patent application bearing the reference 102011003399.8 is a method for determining a position of at least one element which can be moved by a drive belt of a drive unit. In this case the drive belt is stretched over a measurement interval with a predetermined force about a change in displacement. An effective length of the drive belt is determined from the measurement interval and the force, as well as from an elasticity module and a cross-section of the drive belt, and the position is determined from the effective length.

### SUMMARY

One possible object is to specify an alternative method and an alternative apparatus for determining a position of a linearly movable object.

The inventor proposes an apparatus for determining a position of a linearly movable object comprises a contact unit, which is coupled to the object such that it supplies an angle signal dependent on the position of the object, an angle detection unit for detecting the angle signal supplied by the contact unit and an evaluation unit for evaluating the angle signal detected by the angle detection unit.

An apparatus of this type does not require any moving components which are prone to wear in the measurement system and therefore has the advantage of being particularly resistant to wear and of being reliable. Furthermore, the apparatus only requires energy when a position of the object is also read out, and is hence efficient as regards the energy requirement and energy consumption. Furthermore, the apparatus can substantially be disposed in a space through which the object travels, so that the apparatus advantageously requires hardly any additional space.

In a first embodiment the contact unit comprises a linear spring element, tensioned in each position of the object, which spring element is coupled by a first end to the object and by a second end to the angle detection unit, so that an angle between a predefined reference direction and the spring element depends on the position of the object, wherein the angle detection unit detects this angle as an angle signal.

In a second embodiment the contact unit has a mass which is coupled to the object by way of a cable. In this case the cable is guided by way of a deflection apparatus, so that an angle between a predefined reference direction and the section of the cable that runs between the deflection apparatus and the object depends on the position of the object. The angle detection unit detects this angle as an angle signal.

Both configurations provide very easily and inexpensively achievable embodiments. In addition, the forces exerted by the spring element or the mass on the object can also be effective forces which serve to move the object. For example, the spring force of the spring element or the weight force of the mass can enable or assist with the movement of the object.

In a third embodiment the contact unit comprises two straight legs which are movably connected to one another by way of an articulation. In this case one leg is coupled to the object by one end, and one end of the other leg is fixed, so that an angle between the legs depends on the position of the object.

This embodiment too has the advantage of an extremely simple and inexpensive structure.

In the case of the third embodiment an angle between the two legs can be used as an angle signal. This advantageously does not require any additional reference direction to establish the angle. Alternatively, at least one of the angles between a predefined reference direction and a leg can be detected as an angle signal. In particular, the direction of the force of gravity can be used here as a reference direction. This makes it possible to use acceleration sensors as angle detection units and to compensate for centrifugal forces in mobile use.

In a fourth embodiment the contact unit comprises a structure element supplying the angle signal, which is read out by the angle detection unit during the movement of the object. For example, the structure element is helical in shape and is arranged along a movement trajectory of the object. This embodiment has the advantage that the contact unit has no moving components and so is easier to maintain and less prone to repairs.

The inventor also proposes a method for determining a position of a linearly movable object by the proposed apparatus an angle signal supplied by the contact unit is detected by the angle detection unit and the angle signal detected by the angle detection unit is evaluated by the evaluation unit. In this case the position of the object is determined based on an evaluation function which describes a dependence of the angle signal on a coordinate specifying the position of the object.

In the method the position of the object is thus determined based on an evaluation function which assigns an angle signal to the position of the object. In this way a position of the object can be derived from the angle signal during a power outage even after the object is moved manually.

The evaluation function is preferably determined experimentally. This means the evaluation function can be reliably determined under real conditions.

In another embodiment of the method, test positions of the object are predefined and the angle signal is continuously detected at the test positions and is compared to the values of the evaluation function for the test positions. The evaluation function is updated if its values for the test positions differ from the angle signals detected at the test positions.

This advantageously makes it possible to adjust the evaluation function to changing properties of the apparatus.

Thanks to the continuous examination of the evaluation function at predefined positions of the object, necessary adjustments of the evaluation function can be reliably identified and in addition a change over time in the properties of the apparatus can be documented and analyzed.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1A schematically shows a first apparatus for determining a position of a sliding door in an open position of the sliding door,

FIG. 1B schematically shows the apparatus illustrated in FIG. 1A in a closed position of the sliding door,

FIG. 2A schematically shows a second apparatus for determining a position of a sliding door in an open position of the sliding door,

FIG. 2B schematically shows the apparatus illustrated in FIG. 2A in a closed position of the sliding door,

FIG. 3A schematically shows a third apparatus for determining a position of a sliding door in an open position of the sliding door,

FIG. 3B schematically shows the apparatus illustrated in FIG. 3A in a closed position of the sliding door,

FIG. 4A schematically shows a fourth apparatus for determining a position of a sliding door in an open position of the sliding door,

FIG. 4B schematically shows the apparatus illustrated in FIG. 4A in a closed position of the sliding door.

FIG. 5 schematically shows an evaluation function for determining a position of the sliding door.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

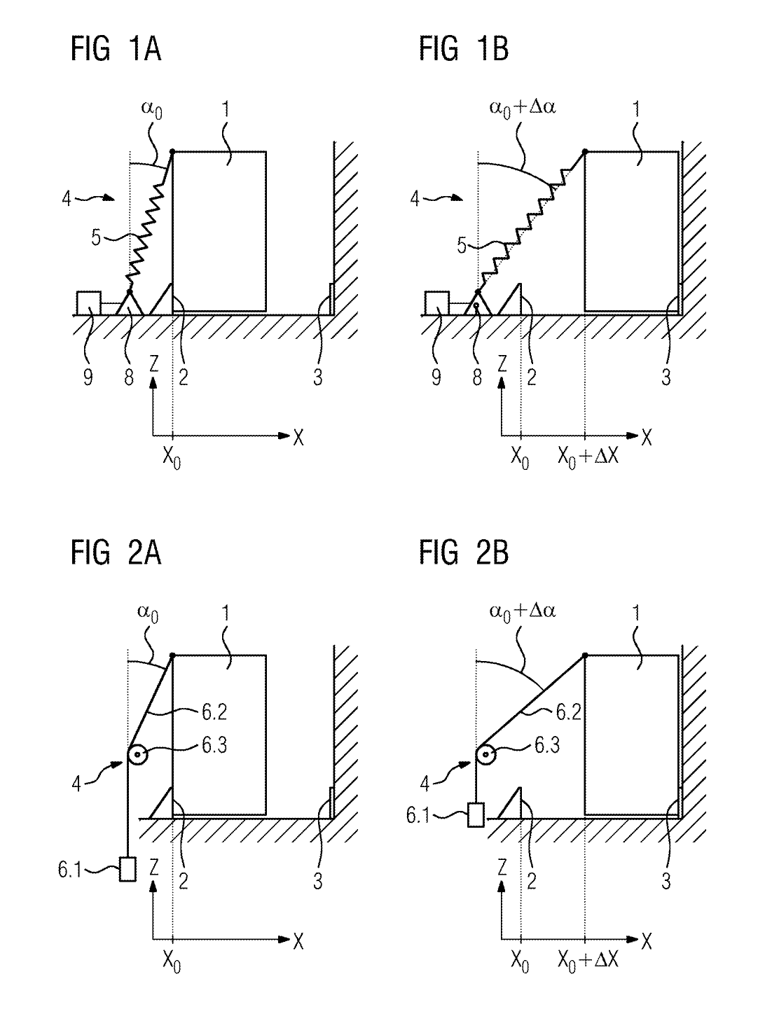

FIGS. 1A to 4B schematically show different apparatuses for determining a position of a linearly movable object 1, which in these exemplary embodiments is a sliding door which can be moved linearly between an open position illustrated in FIGS. 1A, 2A, 3A, 4A and a closed position illustrated in FIGS. 1B, 2B, 3B, 4B. The direction of movement of the sliding door here defines the X direction of a Cartesian coordinate system with coordinates X, Y, Z.

In the open position the sliding door hits a first stop 2. In the closed position the sliding door hits a second stop 3.

The various apparatuses for determining the position of the sliding door each comprise a contact unit 4 coupled to the sliding door and an angle detection unit 8 coupled to the contact unit 4. The contact unit 4 is in each case coupled to the sliding door and the angle detection unit 8 such that it supplies an angle signal a dependent on the position of the sliding door. The angle signal α is detected by the angle detection unit 8. As an angle detection unit 8 a suitable conventional angle sensor can be used here, for example an angle sensor having an absolute incremental encoder, a spring with potentiometric, incremental or magnetic angle detection or a magnetic angle sensor.

The angle signal α detected by the angle detection unit 8 is in each case passed to an evaluation unit 9, by which it is evaluated to determine the position of the sliding door. The angle detection unit 8 and the evaluation unit 9 are not illustrated in all FIGS. 1A to 4B for the sake of clarity.

To evaluate the detected angle signals α, in each case an evaluation function α(X) is used, which describes a dependence of the angle signal α on the position of the sliding door.

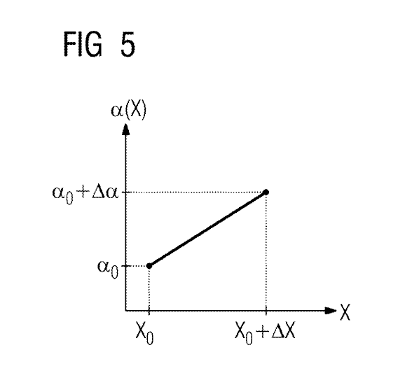

FIG. 5 schematically shows an evaluation function α(X) for all exemplary embodiments illustrated in FIGS. 1A to 4B. The position of the sliding door is here defined by the X coordinate of the door edge of the sliding door which in the open position of the sliding door abuts against the first stop 2 (in FIGS. 1A to 4B this is the left door edge in each case). X0 indicates the position of the sliding door in the open position. X0+ΔX indicates the position of the sliding door in the closed position, i.e. ΔX is the distance between the closed sliding door and the first stop 2. α0 designates the value α(X0) of the evaluation function α(X) when the sliding door is open. α0+Δα designates the value (X0+ΔX) of the evaluation function α(X) when the sliding door is closed. In all exemplary embodiments illustrated the evaluation function α(X) is monotonous and this allows a position of the sliding door to be unambiguously assigned to a detected angle signal α.

The various apparatuses illustrated in FIGS. 1A to 4B substantially differ in the way the contact unit 4 is formed.

FIGS. 1A and 1B show an apparatus whose contact unit 4 is a spring element 5. The spring element 5 is coupled by a first end to the sliding door and by a second end to the angle detection unit 8, so that an angle between the Z direction and the spring element 5 depends on the position of the sliding door. This angle is the angle signal α detected by the angle detection unit 8.

FIGS. 2A and 2B show an apparatus whose contact unit 4 has a mass 6.1, a cable 6.2 and a deflection apparatus 6.3, which is designed as a deflection roller. The mass 6.1 is coupled to the sliding door by way of the cable 6.2 and is guided by way of the deflection apparatus 6.3, so that an angle between the Z direction and the section of the cable 6.2 that runs between the deflection apparatus 6.3 and the sliding door depends on the position of the sliding door. This angle is the angle signal α detected by the angle detection unit 8.

In the exemplary embodiments illustrated in FIGS. 1A to 2B the force exerted by the spring element 5 or the mass 6.1 on the sliding door can be used simply for position determination, or it may be an effective force. In the first case the force should be as small as possible in order not to exert any significant influence on the movement of the sliding door, and should thus lie e.g. in the range between 1 N and 1.5 N. As an effective force the spring force of the spring element 5 or the weight force of the mass 6.1 can for example enable or assist with opening or closing of the sliding door.

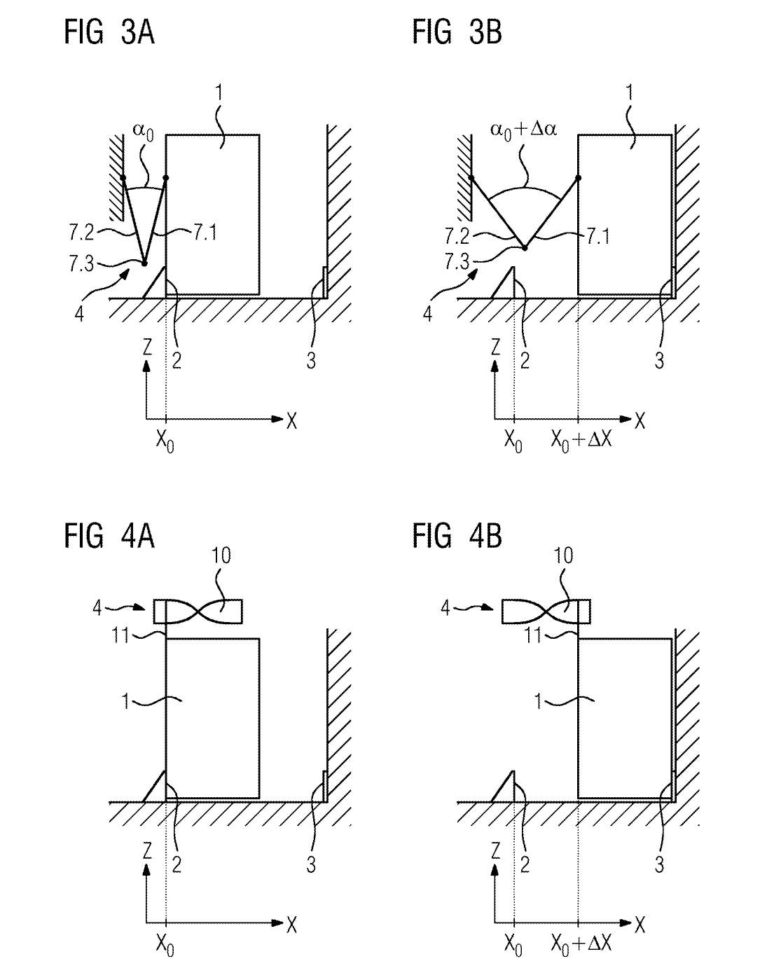

FIGS. 3A and 3B show an apparatus whose contact unit 4 comprises two straight legs 7.1, 7.2 which are movably connected to one another by way of an articulation 7.3. In this case a first leg 7.1 is coupled by one end to the sliding door, and one end of the second leg 7.2 is fixed, so that an angle between the legs 7.1, 7.2 depends on the position of the sliding door. This angle is the angle signal α detected by the angle detection unit 8.

In a variation of the exemplary embodiment shown in FIGS. 3A and 3B the angle signal α detected by the angle detection unit 8 is not the angle between the two legs 7.1, 7.2, but at least one of the angles between one of the legs 7.1, 7.2 and the Z direction.

FIGS. 4A and 4B show an apparatus whose contact unit 4 comprises a structure element 10 which is shaped like a helical strip and is arranged along the movement trajectory of the sliding door and whose helical axis runs in the X direction. A coupling element 11 arranged on the sliding door is guided along the structure element 10 during the movement of the sliding door. By way of this coupling element 11 a location on the structure element 10 and thus an angle along the helix is assigned to the positions of the sliding door in each case. This angle is detected as an angle signal α by the angle detection unit 8. Preferably this angle changes by 180 degrees during the movement of the sliding door between the open position and the closed position.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-13. (canceled)

14. An apparatus for determining a position of an object which can be moved in a linear manner, the apparatus comprising:
a contact unit which is coupled to the object such that it produces an angle dependent on the position of the object;
an angle detection unit to detect the angle produced by the contact unit, and to produce an angle signal based thereon; and
an evaluation unit to evaluate the angle signal produced by the angle detection unit and to determine the position of the object from the angle signal.

15. The apparatus as claimed in claim 14, wherein
the contact unit comprises a linear spring element, tensioned in each position of the object, the linear spring being coupled to one end to the object, so that the angle dependent on the position of the object is an angle between a predefined reference direction and the spring element, and
the angle detection unit detects the angle between the predefined reference direction and the spring element.

16. The apparatus as claimed in claim 15, wherein the spring element exerts an effective force which influences movement of the object.

17. The apparatus as claimed in claim 14, wherein
the contact unit comprises a mass, a cable and a deflection apparatus, the mass being coupled to the object by way of the cable and the deflection apparatus,
the cable is guided by way of the deflection apparatus such that a first section of the cable runs between the object and the deflection apparatus and a second section of the cable runs between the deflection apparatus and the mass,
the angle dependent on the position of the object is an angle between a predefined reference direction and the first section of the cable, and
the angle detection unit detects the angle between the predefined reference direction and the first section of the cable.

18. The apparatus as claimed in claim 17, wherein a weight force of the mass exerts an effective force which influences movement of the object.

19. The apparatus as claimed in claim 14, wherein
the contact unit comprises first and second legs which are movably connected to one another by way of an articulation,
the first leg is coupled to the object, and
the second leg is fixed, so that an angle between the legs depends on the position of the object.

20. The apparatus as claimed in claim 19, wherein the angle detection unit detects the angle between the legs and produces the angle signal based thereon.

21. The apparatus as claimed in claim 19, wherein the angle detection unit produces the angle signal based on an angle between a predefined reference direction and one of the first and second legs.

22. The apparatus as claimed in claim 14, wherein the contact unit comprises a structure element that produces the angle dependent on the position of the object, which structure element is read out by the angle detection unit during the movement of the object.

23. The apparatus as claimed in claim 22, wherein the structure element is helical in shape and is arranged along a movement trajectory of the object.

24. The apparatus as claimed in claim 14, wherein
the contact unit comprises a structure element,
the structure element is helical in shape and is arranged along a movement trajectory of the object, and
the angle dependent on the position of the object is an angle between the object and the structure element.

25. A method for determining a position of a linearly movable object, comprising:
producing an angle dependent on the position of the object using a contact unit coupled to the object;
detecting the angle dependent on the position of the object and producing an angle signal thereform; and
evaluating the angle signal and determining the position of the object based on an evaluation function which describes a dependence of the angle signal on a coordinate specifying the position of the object.

26. The method as claimed in claim 25, wherein the evaluation function is determined experimentally.

27. The method as claimed in claim 25, wherein
test positions of the object are predefined,
the angle dependent on the position of the object is continuously detected at the test positions to produce the angle signal,
the angle signal is compared to values of the evaluation function for the test positions, and
the evaluation function is updated if values for the test positions differ from the angle signals produced at the test positions.
